(19) United States
(12) Patent Application Publication
(10) Pub. No.: US 2008/0081232 A1
(43) Pub. Date: Apr. 3, 2008

(54) CHEMICAL REACTING SYSTEM AND FUEL CELL SYSTEM

(75) Inventors: Masahiro Kuwata, Kawasaki-shi (JP); Yoshiyuki Isozaki, Nerima-ku (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/697,128

(22) Filed: Apr. 5, 2007

(30) Foreign Application Priority Data
Sep. 29, 2006 (JP) 2006-268341

(51) Int. Cl. H01M 8/04; B01J 19/00

(52) U.S. Cl. 429/19; 48/61; 422/198

(57) ABSTRACT

A chemical reacting system includes a high temperature reactor; a low temperature reactor where reaction is conducted at a lower temperature than in the high temperature reactor; and a heat transmission joint with a heat transmission controller to join the high temperature reactor transferably in heat with the low temperature reactor so as to change a transferable heat cross section, thereby controlling a heat quantity to be transferred from the high temperature reactor to the low temperature reactor.

### CROSS-REFERENCE TO RELATED APPLICATIONS

This application is based upon and claims the benefit of priority from the prior Japanese Patent Application No. 2006-268341, filed on Sep. 29, 2006; the entire contents of which are incorporated herein by reference.

### BACKGROUND OF THE INVENTION

1. Field of the Invention

The present invention relates to a chemical reacting system and a fuel cell system which are usable for a small size electronic instrument such as a notebook computer, a digital camera or a handy camera.

2. Description of the Related Art

In a high temperature reactor such as a reformer to reform a fuel into a hydrogen rich gas, conventionally, the heating process is carried out by means of electric heater so as to control the temperature of the reactor (see, Document No. 1). Also, the high temperature reactor is joined with a low temperature reactor by means of a heat transmission joint so that the heat quantity is transferred from the high temperature reactor into the low temperature reactor. In this case, the low temperature reactor is heated by the heat quantity transferred from the high temperature reactor (see, Document No. 2).

[Document No. 1] JP-A 2003-88754(KOKAI)

[Document No. 2] JP-A 2000-154001(KOKAI)

In a conventional fuel cell system, since the electric power generated at the fuel cell is partially consumed by the electric heater to control the temperature of the reformer, the electric power to be utilized by an external electronic instrument is decreased. In a fuel cell system which is configured such that heat quantity is transferred from the high temperature reactor to the low temperature reactor, the heat quantity to be transferred can not be controlled.

### SUMMARY OF THE INVENTION

It is an object of the present invention, in view of the above-described problems, to provide a chemical reacting system which control heat quantity to be transferred from a high temperature reactor to a low temperature reactor. It is also an object to provide a fuel cell system which is configured to utilize the electric power generated by the fuel cell effectively at an external instrument.

In order to achieve the above object, an aspect of the present invention relates to a chemical reacting system comprises: a high temperature reactor; a low temperature reactor where reaction is conducted at a lower temperature than in the high temperature reactor; and a heat transmission joint with a heat transmission controller to join the high temperature reactor transferably in heat with the low temperature reactor so as to change a transferable heat cross section, thereby controlling a heat quantity to be transferred from the high temperature reactor to the low temperature reactor.

Another aspect of the present invention relates to a fuel cell system includes: a high temperature reactor to reform a fuel into a reformed gas containing hydrogen; a low temperature reactor to conduct a reaction for the reduction of amount of carbon monoxide contained in the reformed gas at a lower temperature than in the high temperature reactor; a fuel cell to generate an electric power by using the reformed gas discharged from the low temperature reactor; a combustor to combust an unreacted gas discharged from said fuel cell; a heat transmission joint with a heat transmission controller to join the high temperature reactor transferably in heat with the low temperature reactor so as to change a transferable heat cross section, thereby controlling a heat quantity to be transferred from the high temperature reactor to the low temperature reactor; a temperature detector to detect a temperature of the high temperature reactor or the combustor; and a controller, on the temperature detected by the temperature detector, to control the electric power to be generated at the fuel cell and change an amount of hydrogen contained in the unreacted gas discharged from the fuel cell.

Still another aspect of the present invention relates to a fuel cell system includes: a high temperature reactor to reform a fuel into a reformed gas containing hydrogen; a low temperature reactor to conduct a reaction for the reduction of amount of carbon monoxide contained in the reformed gas at a lower temperature than in the high temperature reactor; a fuel cell to generate an electric power by using the reformed gas discharged from the low temperature reactor; a combustor to combust an unreacted gas discharged from the fuel cell; a heat transmission joint with a heat transmission controller to join the high temperature reactor transferably in heat with the low temperature reactor so as to change a transferable heat cross section, thereby controlling a heat quantity to be transferred from the high temperature reactor to the low temperature reactor; a temperature detector to detect a temperature of the high temperature reactor or the combustor; and a controller, on the temperature detected by the temperature detector, to control an amount of the fuel to be supplied to the high temperature reactor and change an amount of hydrogen contained in the unreacted gas discharged from the fuel cell.

According to the chemical reacting system of the aspect, heat quantity to be transferred from a high temperature reactor to a low temperature reactor can be controlled. According to the fuel cell system of the aspects, electric power generated by the fuel cell can be utilized effectively at an external instrument.

### BRIEF DESCRIPTION OF THE DRAWINGS

FIG. 1 is a perspective view schematically showing a chemical reacting system according to one embodiment.

FIG. 2 is a cross sectional view schematically showing the heat conductive joint with the heat transmission quantity controller in the chemical reacting system.

FIG. 3 is a cross sectional view schematically showing the contacting surface between the trench surface of the heat transmission joint and the surface of the heat transmission fitter.

FIG. 4 is a cross sectional view schematically showing a heat transmission joint and a heat transmission controller in the chemical reacting system.

FIG. 5 is a cross sectional view schematically showing the heat transmission joint and the heat transmission controller in the chemical reacting system.

FIG. 6 is a cross sectional view schematically showing another heat transmission joint and another heat transmission controller in the chemical reacting system.

FIG. 7 is a cross sectional view schematically showing still another heat transmission joint and still another heat transmission controller in the chemical reacting system.

FIG. 8 is a cross sectional view schematically showing a further heat transmission joint and a further heat transmission controller in the chemical reacting system.

FIG. 9 is a cross sectional view schematically showing another heat transmission joint and another heat transmission controller in the chemical reacting system.

FIG. 10 is a schematic view showing the system of a fuel cell system according to one embodiment.

FIG. 11 is a calculation model for the temperature control when the high temperature reactor is joined with the low temperature reactor with the heat transmission joint with heat transmission controller.

FIG. 12 is a graph showing the relation between the outside temperature and the low temperature reactor.

### DESCRIPTION OF THE EMBODIMENTS

Hereinafter, the present invention will be described in detail with reference to the drawings.

(Chemical Reacting System)

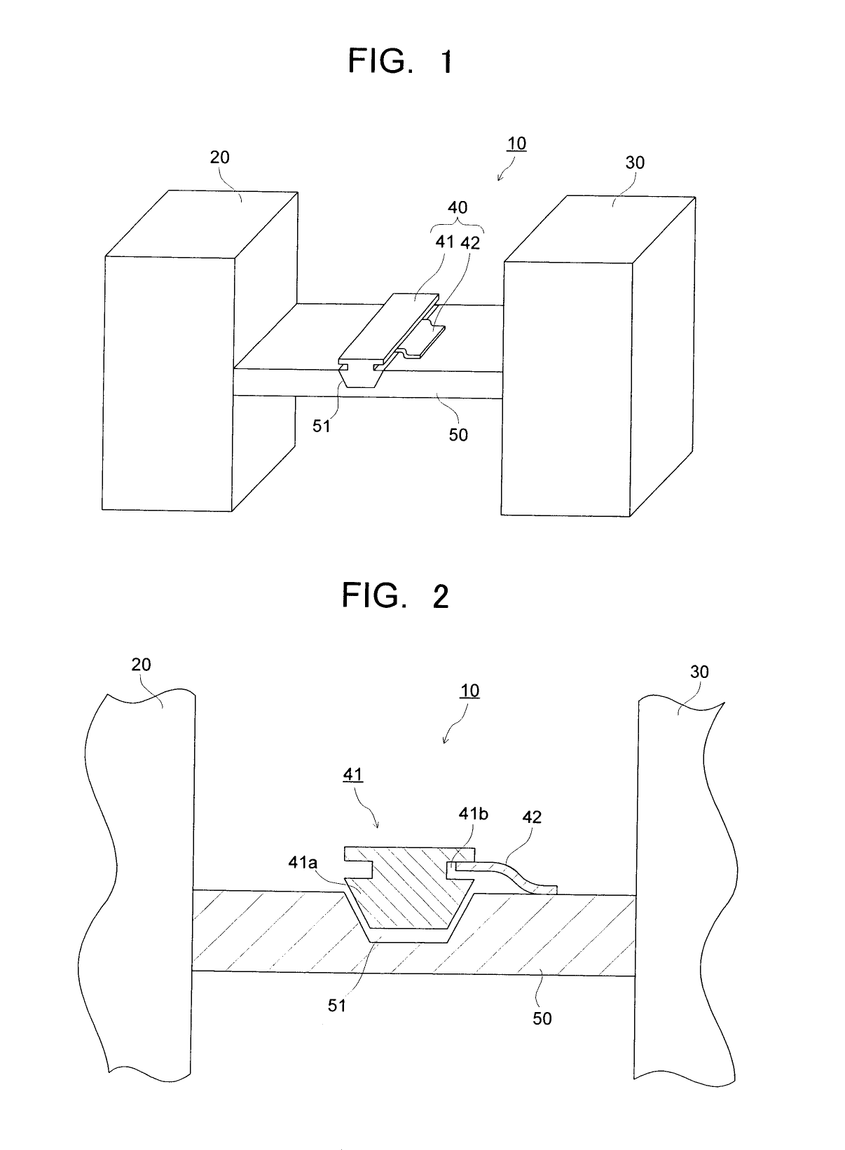

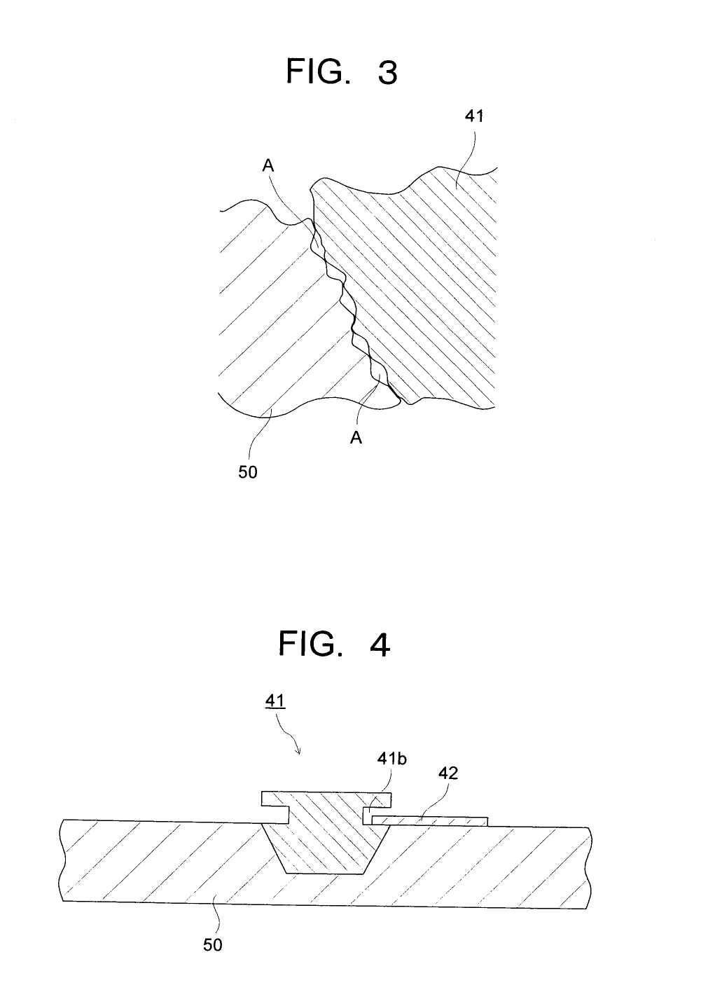

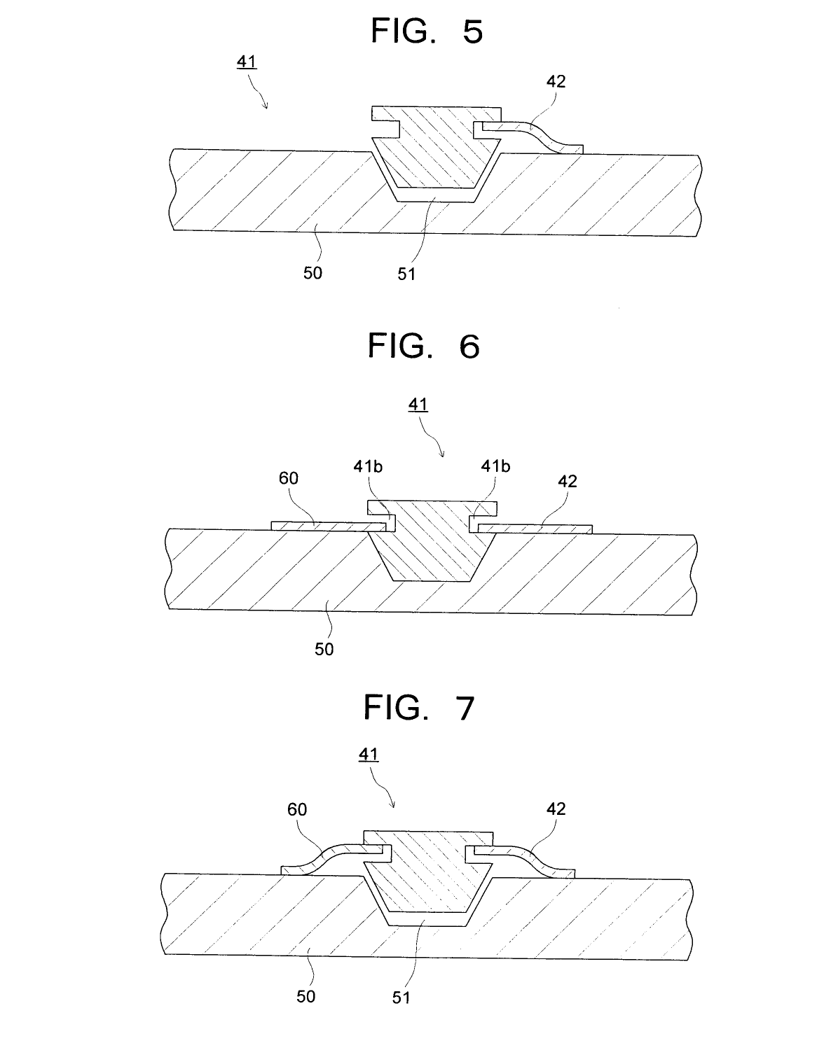

FIG. 1 is a perspective view schematically showing a chemical reacting system 10 according to one embodiment. FIG. 2 is a cross sectional view schematically showing a heat transmission joint 50 with a heat transmission controller 40 in the chemical reacting system 10. FIG. 3 is a cross sectional view schematically showing the contacting surface between the surface of the trench 51 of the heat transmission joint 50 and the surface of the heat transmission fitter 41. FIGS. 4 and 5 are cross sectional views schematically showing the heat transmission joint 50 and the heat transmission controller 40 in the chemical reacting system. FIGS. 6 to 9 are cross sectional view schematically showing another heat transmission joint and another heat transmission controller in the chemical reacting system, respectively.

As is apparent from FIG. 1, the chemical reacting system 10 mainly includes a high temperature reactor 20 and a low temperature reactor 30, the heat transmission joint 50 with the heat transmission controller 40.

The high temperature 20 is configured so as to realize a high temperature reaction, and can be exemplified as a combustor or a reformer in a fuel cell system, for example.

The low temperature reactor 30 is configured so as to realize a lower temperature reaction than in the high temperature reactor, and can be exemplified as a CO transformer to reduce a carbon monoxide (CO) concentration in a reformed gas.

Herein, as the concrete chemical reacting system with the high temperature reactor 20 and the low temperature reactor 30, the combustor, the reformer and the CO transformer to be employed in the fuel cell system are exemplified, but the chemical reacting system may not be restricted to the above-exemplified ones. The chemical reacting system can be structured by the high temperature reactor 20 and the low temperature reactor 30 which is configured so as to realize the lower temperature reaction than in the high temperature reactor 20.

The heat transmission joint 50 joins the high temperature reactor 20 transferably in heat with the low temperature reactor 30. In this case, heat quantity is transferred from the high temperature reactor 20 toward the low temperature reactor 30. A trench 51 is formed at the heat transmission joint 50 so as to intersect with the heat transmission direction between the high temperature reactor 20 and the low temperature reactor 30. Only if the requirement of the trench 51 being formed so as to intersect with the heat transmission direction, that is, the long direction of the heat transmission joint 50, is satisfied, the intersecting angle between the heat transmission direction and the long direction of the trench is not restricted. For example, as shown in FIG. 1, the long direction of the trench 51 may be orthogonal to the long direction of the heat transmission joint 50 (the direction from the joint of the high temperature reactor 20 toward the joint of the low temperature reactor 30). The shape of the trench 51 is configured so as to match the shape of the heat transmission controller 40 to be embedded in the trench 51. The cross section of the trench 51 is not limited, but preferably, the contacting area between the surface of the trench 51 and the surface of the heat transmission controller 40 is set larger. For example, as shown in FIG. 2, the cross section of the trench 51 is shaped in trapezoid.

The heat transmission controller 40 includes a columnar heat transmission fitter 41 to be embedded and fitted into the trench 51 of the heat transmission joint 50 and a temperature sensitive member 42 to press the heat transmission fitter 41 into the trench 51 of the heat transmission joint 50.

The cross section of the fitting portion 41a of the heat transmission fitter 41 to be embedded and fitted into the trench 51 of the heat transmission joint 50 is configured so as to match the shape of the trench 51. The heat transmission fitter 41 is joined with the heat transmission joint 50 via the temperature sensitive member 42. The one edge of the temperature sensitive member 42 is set to be fixed and the other edge of the temperature sensitive member 42 is set to be free. For example, an engaging trench 41b is formed at the upper side of the heat transmission fitter 41 along the long direction of the fitter 41 so as to be engaged with the one end of the temperature sensitive member 42.

The one end of the temperature sensitive member 42 is fixed to the heat transmission joint 50 by means of screw clamp or welding. The other end of the temperature sensitive member 42 is set to be free so as to be engaged with and not fixed to the engaging trench 41b so that the temperature sensitive member 42 can be easily shifted vertically through the release and engagement of the other end of the temperature sensitive member 42 from and with the trench 51. Since the other end of the temperature sensitive member 42 is engaged with the engaging trench 41b, the heat transmission fitter 41 can be supported by the temperature sensitive member 42. The temperature sensitive member 41 is made of a material to be easily deformed by heating, and deformed by fitting the heat transmission fitter 41 into the trench 51, that is, by moving the heat transmission fitter 41 downward in FIG. 2, or releasing the heat transmission fitter 41 from the trench 51, that is, by moving the heat transmission fitter 41 upward in FIG. 2. It is desired that the temperature sensitive member 42 is made of a material for the heat transmission fitter 41 to be pressed into the trench 51 in order to reduce the thermal contact resistance between the surface of the trench 51 of the heat transmission joint 50 and the surface of the heat transmission fitter 41. Concretely, the temperature sensitive member 42 is preferably made of bimetal or shape-memory alloy.

Then, the contacting surface between the surface of the trench 51 of the heat transmission joint 50 and the surface of the heat transmission fitter 41 will be described.

As shown in FIG. 3, since the surface of the trench 51 of the heat transmission joint 50 and the surface of the heat transmission fitter 41 are waved and roughed, the contacting surface between the surface of the trench 51 of the heat transmission joint 50 and the surface of the heat transmission fitter 41 can exhibit the solid heat transmission through the contact between the solid portions of the trench 51 and the solid portions of the heat transmission fitter 41 and includes minute vacancies with small heat conductivity formed by the contact of the solid portions. In this way, since the vacancies A are formed at the contacting surface between the solid portions of the trench 51 and the heat transmission fitter 41, the heat resistance between the trench 51 and the heat transmission fitter 41 is enhanced so as to form the thermal contact resistance between the trench 51 and the heat transmission fitter 41.

The thermal contact resistance R can be represented by the equation (1) (refer to “JSME Data Book: Heat Transfer 4th Edition; The Japan Society of Mechanical Engineers; p. 31)

$$\frac{1}{R} = 0.6 \frac{1.7 ⨯ {10}^{5}}{\frac{{δ}_{1} + {δ}_{0}}{{λ}_{1}} + \frac{{δ}_{2} + {δ}_{0}}{{λ}_{2}}} \frac{P}{H} + \frac{{10}^{6} {λ}_{f}}{{δ}_{1} + {δ}_{2}} \qquad [ Equation 1 ]$$

Herein, λ1 is a heat conductivity of the surface of the trench 51, λ2 is a heat conductivity of the surface of the heat transmission fitter 41, λf is a heat conductivity of air (vacancies) at the contacting surface between the trench 51 and the heat transmission fitter 41, δ0 is a constant, δ1 is a jumping distance at the surface of the trench 51, δ2 is a jumping distance at the surface of the heat transmission fitter 41, P is a pressing pressure, and H is a hardness (Vickers hardness).

It is desired that the thermal contact resistance R is set small so as to enhance the heat quantity to be transferred via the contacting surface between the surface of the trench 51 of the heat transmission joint 50 and the surface of the heat transmission fitter 41. In view of the equation (1), it is desired that the heat transmission fitter 41 is pressed against the trench 51 so as to enhance the pressing pressure (P). It is also desired that at least the surface of the trench 51 and the surface of the heat transmission fitter 41 are made of materials with high heat conductivity and hardness small enough to increase the contacting surface by the pressing pressure (P). Concretely, the surface of the trench 51 and the surface of the heat transmission fitter 41 are made of materials with high heat conductivity and Vickers hardness of 100 or below. The heat conductivities of the materials are preferably set to 50 W/(m·K) or over, respectively. Concretely, as such high heat conductivity and hardness material, aluminum (Al), aluminum alloy and cupper (Cu) can be exemplified, but any kind of material can be employed only if the above-described requirements are satisfied. The high heat conductivity and small hardness materials may be coated on the surface of the trench 51 and the heat transmission fitter 41. The trench 51 and the heat transmission fitter 41 may be made entirely of high heat conductivity and small hardness materials, respectively.

When the heat transmission joint 50 and the heat transmission fitter 41 are made entirely of the materials with small hardness such as Al, Al alloy or Cu, the heat quantity more as desired may be transferred from the high temperature reactor 20 to the low temperature reactor 30. It is desired that the heat transmission controller 40 and the heat transmission joint 50 may be made of materials with corrosion-resistance and oxidation-resistance. In this point of view, the heat transmission controller 40 and the heat transmission joint 50 are preferably made of materials with smaller heat conductivity than Al, Al alloy or Cu (e.g., less than 50 W/(m·K)) and high corrosion resistance and oxidation resistance. Concretely, stainless steel may be exemplified, but another kind of material may be employed only if the above-described requirement is satisfied. The stainless steel has a larger hardness than Al, Al alloy or Cu and may increase the thermal contact resistance in the use for the heat transmission controller 40 and the heat transmission joint 50. Therefore, it is desired that the surface area of the trench 51 of the heat transmission joint 50 and the surface area of the heat transmission fitter 41 are made of high heat conductivity materials with Vickers hardness of 100 or below such as Al, Al alloy or Cu.

The formation of the surface layers of the trench 51 of the heat transmission joint 50 and the heat transmission fitter 41 can be carried out by means of film forming technique or electrotyping. The other areas except the surfaces of the heat transmission joint 50 and the heat transmission fitter 41 may be made of stainless steel.

As shown in the equation (1), as the contacting surface becomes flat and thus, the surface roughness of the contacting surface is decreased so that the jumping distance between the solid portions at the contacting surface is decreased, the thermal contact resistance R becomes small. In order to transfer large heat quantity at the joint between the heat transmission joint 50 and the heat transmission fitter 41, the surface roughness Ra of the surfaces of the trench 51 of the heat transmission joint 50 and the heat transmission fitter 41 are preferably set to 6.3 or below, more preferably to 1.6 or below, particularly to 0.2 or below.

Then, the operation of the heat transmission controller 40 of the heat transmission joint 50 in the chemical reacting system 10 will be described.

For example, when the temperature of the low temperature reactor 30 is lower than a prescribed temperature, the temperature sensitive member 42 is deformed in response to the low temperature so that the heat transmission fitter 41 can be pressed and deformed to fit in the trench 51. In this case, in FIG. 4, the heat transmission fitter 41 is deformed and moved downward. According to the deformation of the temperature sensitive member 42, the heat transmission fitter 41 is fitted and pressed under a give pressure in the trench 51. In this case, the cross section of the heat transmission joint 50 which is fitted and pressed into the trench 51 is enlarged orthogonal to the heat transmission direction so that the heat quantity from the high temperature reactor 20 to the low temperature reactor 30 can be enhanced.

In contrast, when the temperature of the low temperature reactor 30 is higher than a prescribed temperature, the temperature sensitive member 42 is deformed in response to the low temperature so that the heat transmission fitter 41 can be released from the trench 51. In this case, in FIG. 5, the heat transmission fitter 41 is deformed and moved upward. According to the deformation of the temperature sensitive member 42, the heat transmission fitter 41 is released from the trench 51 so as to form a given space against the trench 51. In this case, the cross section of the heat transmission joint 50 which is fitted and pressed into the trench 51 is decreased orthogonal to the heat transmission direction so that the heat quantity from the high temperature reactor 20 to the low temperature reactor 30 can be lowered. Herein, even though the heat transmission fitter 41 is released from the trench 51, the heat transmission from the high temperature reactor 20 to the low temperature rector 30 is always conducted because the high temperature reactor 20 is joined transferably in heat with the low temperature reactor 20 via the heat transmission joint 50.

In the case that the temperature of the low temperature reactor 30 is higher or lower than the prescribed temperature, if the difference between the temperature of the low temperature reactor 30 and the prescribed temperature is small, the pressure of the heat transmission fitter 41 against the trench 51 is reduced so as to deform the temperature sensitive member 42 to the degree enough to increase the thermal contact resistance R. In this case, therefore, it is not required to release the heat transmission fitter 41 from the trench 51 so as to form the space in the trench 51. According to this embodiment, the heat quantity to be transferred can be finely controlled.

In this embodiment, although the temperature sensitive member 42 is provided in the side of the low temperature reactor 30, the temperature sensitive member 42 may be provided in the side of the high temperature reactor 20. Moreover, as shown in FIGS. 6 and 7, the temperature sensitive members 42 and 60 may be provided in the side of the low temperature reactor 30 and the high temperature reactor 20, respectively.

Then, the operation of the heat transmission controller 40 of the heat transmission joint 50 will be described when the temperature sensitive members 42 and 60 are provided in the side of the low temperature reactor 30 and in the side of the high temperature reactor 20, respectively.

For example, when the temperature of the low temperature reactor 30 is lower than a prescribed temperature, the temperature sensitive members 42 and 60 are deformed in response to the low temperature so that the heat transmission fitter 41 can be pressed and deformed to fit in the trench 51, as shown in FIG. 6. In this case, the heat transmission fitter 41 is deformed and moved downward. According to the deformation of the temperature sensitive members 42 and 60, the heat transmission fitter 41 is fitted and pressed under a give pressure in the trench 51. In this case, the cross section of the heat transmission joint 50 which is fitted and pressed into the trench 51 is enlarged orthogonal to the heat transmission direction so that the heat quantity from the high temperature reactor 20 to the low temperature reactor 30 can be enhanced.

In contrast, when the temperature of the low temperature reactor 30 is higher than a prescribed temperature, the temperature sensitive members 42 and 60 are deformed in response to the low temperature so that the heat transmission fitter 41 can be released from the trench 51, as shown in FIG. 7. In this case, the heat transmission fitter 41 is deformed and moved upward. According to the deformation of the temperature sensitive members 42 and 60, the heat transmission fitter 41 is released from the trench 51 so as to form a given space against the trench 51. In this case, the cross section of the heat transmission joint 50 which is fitted and pressed into the trench 51 is decreased orthogonal to the heat transmission direction so that the heat quantity from the high temperature reactor 20 to the low temperature reactor 30 can be lowered. Herein, even though the heat transmission fitter 41 is released from the trench 51, the heat transmission from the high temperature reactor 20 to the low temperature rector 30 is always conducted because the high temperature reactor 20 is joined transferably in heat with the low temperature reactor 20 via the heat transmission joint 50.

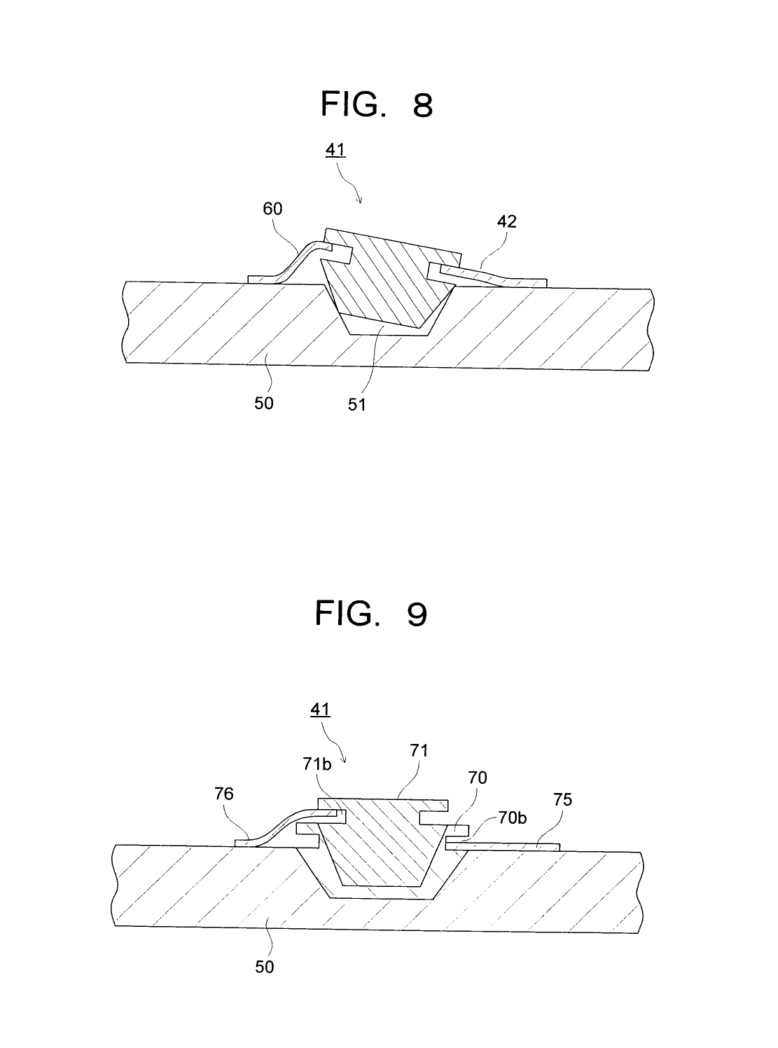

The temperature sensitive members 42 and 60 may be different in deformation degree from one another, originated from the temperature characteristics thereof. In this case, the different deformation between the temperature sensitive members 42 and 60 can be utilized. As shown in FIG. 8, when the temperature of the low temperature reactor 30 is higher or lower than a prescribed temperature, it may be that the temperature sensitive member 60 in the side of the high temperature reactor 20 is relatively largely deformed and the temperature sensitive member 42 in the side of the low temperature reactor 30 is relatively small deformed if the difference between the temperature of the low temperature reactor 30 and the prescribed temperature is small. In this case, the heat transmission fitter 41 is contacted obliquely with the trench 51. Therefore, since the cross section of the heat transmission joint 50 which is fitted and pressed into the trench 51 is decreased orthogonal to the heat transmission direction so that the heat quantity from the high temperature reactor 20 to the low temperature reactor 30 can be reduced. In this embodiment, the heat quantity to be transferred can be controlled finely.

In contrast, when the temperature of the high temperature reactor 20 is higher or lower than a prescribed temperature, the heat transmission fitter 41 is deformed in response to the temperature of the reactor so that the heat quantity from the high temperature reactor 20 to the low temperature reactor 30 can be enhanced or reduced.

In the chemical reacting system 10 in this embodiment, since the high temperature reactor 20 is joined transferably in heat with the low temperature reactor 30 and the heat transmission joint 50 with the heat transmission controller 40 which can change the cross section of the joint 50 to control the heat quantity to be transferred is provided, the heat quantity from the high temperature reactor 20 to the low temperature reactor 30 can be controlled.

Since the surface area of the trench 51 of the heat transmission joint 50 and the surface area of the heat transmission fitter 41 are made of the high conductivity materials with Vickers hardness of 100 or below, the resultant thermal contact resistance can be reduced and the heat conductivity can be enhanced.

Herein, a plurality of trenches 51 may be formed at the heat transmission joint 50 along the long direction so as to intersect the heat transfer direction such that the heat transmission controllers 40 are formed at the trenches 51, respectively. Then, a plurality of heat transmission joints 50 with the respective heat transmission controller 40 may be provided between the high temperature reactor 20 and the low temperature reactor 30. When the heat transmission joints 50 with the respective heat transmission controllers 40 are provided between the high temperature reactor 20 and the low temperature reactor 30, other heat transmission joints with the respective heat transmission controller may be provided at the respective areas between the adjacent heat transmission joints 50.

As shown in FIG. 9, the heat transmission fitter 41 may be configured such that a plurality of separable heat transmission fitters 70 and 71 are stacked one another and contain temperature sensitive members 75 and 76, respectively, thereby forming the heat transmission controller 41. The one ends of the temperature sensitive members 75 and 76 are fixed to the heat transmission joint 50 by means o screw clamp or welding in the same manner as the above embodiments. The other ends of the temperature sensitive members 75 and 76 are not fixed to but engaged with the engagement trenches 70b and 71b formed along the long direction of the heat transmission fitters 70 and 71 so that the temperature sensitive members 75 and 76 can be easily moved vertically so as to fit and release the heat transmission fitter in and from the trench 51. In other words, the other ends of the temperature sensitive members 75 and 76 are set to be free. In this way, the heat transmission fitter 41 may be configured such that the heat transmission fitters 70 and 71 can be moved dependently and vertically in response to the temperatures of the temperature sensitive members 75 and 76, respectively and thus, the cross section of the heat transmission which is fitted in the trench 51 can be controlled orthogonal to the heat transmission direction.

In this embodiment, although the temperature sensitive member 76 is fixed to the heat transmission joint 50, the temperature sensitive member 76 may be fixed to the heat transmission fitter 70.

As described above, a plurality of heat transmission controllers 40 may be provided along the long direction of the heat transmission joint 50. Then, a plurality of heat transmission joints 50 with the respective heat transmission controllers 40 may be provided between the high temperature reactor 20 and the low temperature reactor 30. Then, the heat transmission fitter 41 may be configured such that the separable heat transmission fitters 70 and 71 are stacked one another. In these cases, the same function/effect as the above-mentioned embodiments, that is, the chemical reacting system 10, can be realized, and the heat quantity to be transferred from the high temperature reactor 20 to the low temperature reactor 30 can be controlled finely.

(Fuel Cell System)

Then, the application of the chemical reacting system 10 for a fuel cell system 100 will be described.

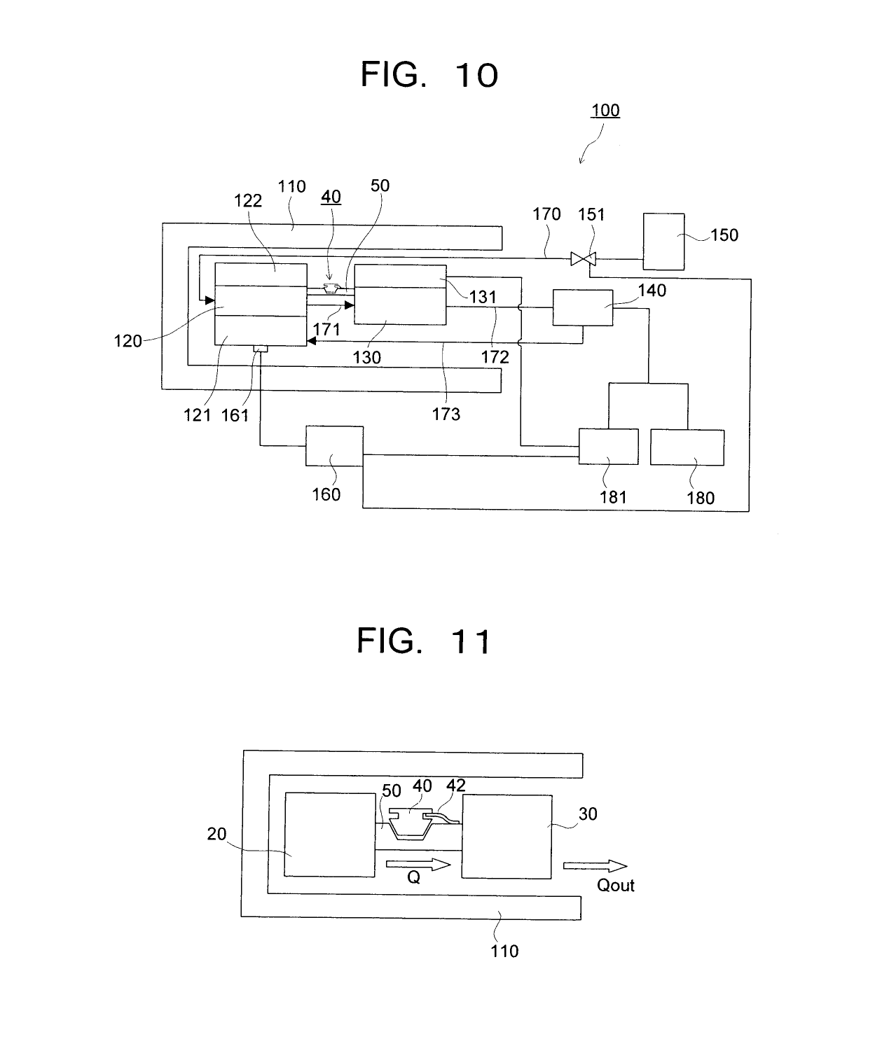

FIG. 10 is a schematic view showing the system of a fuel cell system 100 according to one embodiment.

As shown in FIG. 10, the fuel cell system 100 includes a reformer 120 in a heat insulating container 110, a CO transformer 130 and the heat transmission joint 50 with the heat transmission controller 40. Then, the fuel cell system 100 includes a fuel cell 140, a fuel supplier 150 and a controller 160 outside the heat insulating container 110.

The heat insulating container 110 is made of a vacuum heat insulating container where the airtight space formed between the inner wall and the outer wall is maintained in vacuum and of which one end is opened. The fuel supplier 150 is joined with the reformer 120 via a fuel supplying path 170 made of a tube so as to supply the fuel from the fuel supplier 150 such as fuel tank to the reformer 120. Herein, if a liquid fuel is supplied from the fuel supplier 150, a vaporizer is preferably provided in the middle of the fuel supplying path 170 in the heat insulating container 110.

The reformer 120 reforms the fuel from the fuel supplier 150 into a reformed gas containing hydrogen at a high temperature of about 350° C., for example. Since the reforming reaction is an endothermal reaction, the reformer 120 includes a combustor 121 to combust the offgas from the fuel cell 140. Then, the reformer 120 also includes an electrothermal heater 122 to supply a supplemental thermal energy thereto and control the temperature thereof finely. The combustor 121 functioning as a high temperature reactor includes a temperature detector 161 such as a thermocouple, a thermistor or platinum resistance thermometer. The temperature detector 161 may be provided at the reformer 120 functioning as the high temperature reactor.

The reformer 120 is provided at the rear end of the heat insulating container 110 with receded from the opening so as to reduce the heat loss and heat damage to the outside. The reformer 120 may include additional components for reforming the fuel into the intended reformed gas in addition to the above-described components. One or some components of the reformer 120 may be substituted with other ones and omitted.

The CO transformer 130 removes carbon monoxide contained in the reformed gas from the reformer 120 and poisoning the electrode catalyst of the fuel cell 140, and is connected with the reformer 120 via a reformed gas guiding path 171 made of a tube. At the CO transformer 130, the CO transforming reaction to remove the CO under a high temperature condition of 250° C., for example, is created. The heat transmission joint 50 with the heat transmission controller 40 is provided between the reformer 120 as the high temperature reactor and the CO transformer 130 as the low temperature reactor. The heat transmission joint 50 may be provided between the combustor 121 as the high temperature reactor and the CO transformer 130. The CO transformer 130 includes an electrothermal heater 131 to supply a supplemental thermal energy to the transformer 130 and to control the temperature of the transformer 130 finely.

The fuel cell 140 generates an electric energy through the oxidation-reduction reaction between the supplied fuel and the oxygen gas, and is connected with the CO transformer 130 via a reformed gas discharging path 172 made of a tube. The reformed gas from which the CO gas is removed at the CO transformer 130 is supplied to the fuel electrode of the fuel cell 140 via the reformed gas discharging path 172. The fuel cell 140 is also connected with the combustor 121 via an offgas supplying path 173 made of a tube to supply the offgas from the fuel cell 140 to the combustor 121. Moreover, the fuel cell 140 is electrically connected with an electronic instrument 180 to supply the electric energy generated at the fuel cell 140 and a storage cell 181 such as a battery. The storage cell 181 can change the electric energy to be generated at the fuel cell 140. The storage cell 181 is electrically connected with the electrothermal heaters 122 and 131.

The controller 160 inputs the temperature information from the temperature detector 161, and controls the electric power at the fuel cell 140 and/or the quantity of flow of the fuel to be supplied in the reformer 120, thereby controlling the amount of hydrogen contained in the offgas as an unreacted gas which is discharged from the fuel cell 140. In this point of view, the controller 160 is electrically connected with the temperature detector 161, the storage cell 181 and the fuel flow rate controlling valve 151 provided in the middle of the fuel supplying path 170. In this case, the storage cell 181, the fuel flow rate controller 151 and the like are operated by the controller 160.

In this case, the electric power at the fuel cell 140 can be controlled by changing the electric energy to be stored in the storage cell 181. For example, when the outside air temperature is changed so as to increase the heat quantity to be discharged from the opening of the heat insulating container 110, the heat transmission controller 40 provided at the heat transmission joint 50 is operated to increase the heat quantity to be transferred from the reformer 120 and/or the combustor 121 as the high temperature reactors to the CO transformer 130. In the operation, the heat quantities of the reformer 120 and/or the combustor 121 are short so that the temperatures of the reformer 120 and/or the combustor 121 may be lowered. When the decrease in temperature of the combustor 121 and/or the reformer 120 as the high temperature reactors is detected, the controller 160 lowers the electric power at the fuel cell 140 and thus, decrease the electric energy to be stored in the storage cell 181. Therefore, the amount of hydrogen contained in the offgas discharged from the fuel cell 140 is increased so that the thermal energy supplied from the combustor 121 is increased and thus, the temperature of the reformer 120 is increased.

The control of the flow rate of the fuel to be supplied to the reformer 120 can be realized by controlling the fuel flow rate controlling valve 151 provided in the middle of the fuel supplying path 170. When the decrease in temperature of the combustor 121 and/or the reformer 120 as the high temperature reactors is detected, the controller 160 opens the fuel flow rate controlling valve 151 gradually and thus, increases the fuel quantity to be supplied to the reformer 120. In this case, since the reformed gas quantity to be supplied from the CO transformer 130 to the fuel cell 140 is increased so that the excess reformed gas is supplied to the fuel cell 140, the amount of hydrogen contained in the offgas discharged from the fuel cell 140 is increased. Therefore, the thermal energy to be supplied from the combustor 121 is increased so that the temperature of the reformer 120 can be increased.

The controller 160 may be configured so as to switch or conduct simultaneously the control of the electric energy at the fuel cell 140 and the control of the fuel quantity to be supplied to the reformer 120.

Herein, the electric energy to be required in the electrothermal heater 131 provided at the CO transformer 130 will be described when only the heat transmission joint is provided between the reformer 120, the combustor 121 as the high temperature reactor and the CO transformer 130 as the low temperature reactor and when the heat transmission joint 50 with the heat transmission controller 40 is provided between the reformer 120, the combustor 121 and the CO transformer 130. Suppose that the reformer 120 and the combustor 121 are operated at 350° C. and the CO transformer 130 is operated at 250° C.

Since the fuel cell system 100 is used at an outside air temperature under a general living environment, the heat balance of the fuel cell system 100 is required to be maintained within a temperature range of 0 to 35° C. In the fuel cell system 100, the heat quantity of about 6 W is discharged from the opening of the heat insulating container 110 at the outside air temperature of 0° C., and the heat quantity of about 3 W is discharged from the opening of the heat insulating container 110 at the outside air temperature of 35° C.

In the case of the provision of only the heat transmission joint, suppose that the minimum heat quantity (the heat quantity at the outside air temperature of 35° C.) discharged from the opening of the heat insulating container 110 is transferred to the CO transformer 130 operated at 250° C. from the reformer 120 or the combustor 121 operated at 350° C. under the condition of the temperature difference of 100° C. In this case, when the outside air temperature is decreased to a given temperature lower than 35° C., the heat quantity to be discharged from the opening of the heat insulating container 110 is increased and the short heat quantity (0 to 3 W) at the CO transformer 130 is required to be compensated by the electrothermal heater 131.

In the case of the provision of the heat transmission joint 50 with the heat transmission controller 40, when the heat quantity is transferred to the CO transformer 130 operated at 250° C. from the reformer 120 or the combustor 121 operated at 350° C. under the condition of the temperature difference of 100° C., the heat quantity can be set to 6 W under the condition of the outside air temperature of 0° C. and to 3 w under the condition of the outside air temperature of 35° C. by the heat transmission controller 40. As a result, when the outside air temperature is decreased to a given temperature lower than 35° C., the short heat quantity (0 to 3 W) at the CO transformer 130 is not required to be positively compensated by the electrothermal heater 131. In this case, the electrothermal heater 131 can be utilized as a supplemental instrument to control the temperature of the CO transformer 130 finely.

Then, the heat efficiency is compared in the case that the CO transformer 130 is heated by the electrothermal heater 131 using the electric energy as only the heat transmission joint is provided and in the case that the CO transformer 130 is heated by the thermal energy from the combustor 121 by controlling the amount of hydrogen contained in the offgas discharged from the fuel cell 140 as the heat transmission joint 50 with the heat transmission controller 40 is provided.

In the above exemplified cases, the conversion efficiency of the thermal energy for the amount of hydrogen contained in the reformed gas reformed by the reformer 120 and the CO transformer 130 will described as follows:
Electric energy: Electric power/amount of hydrogen=0.58 [Equation 2]
Thermal energy from combustion: (Heat quantity by combustion−Heat quantity of discharged reconverted gas)/amount of hydrogen=0.92 [Equation 3]

For example, when the temperature control of the CO transformer 130 requires a maximum heat quantity of 3 W, the heat quantity of 5.2 W (3 W/0.58) is required at the use of the electric energy and the heat quantity of 3.3 W (3 W/0/92) is required at the use of the thermal energy from combustion on the equations (2) and (3). Therefore, when the thermal energy from combustion is employed, that is, the heat transmission joint 50 with the heat transmission controller 40 is employed, the amount of hydrogen corresponding to the heat quantity of 1.9 W at maximum can be saved.

According to the fuel cell system 100 in this embodiment, the control of the electric energy at the fuel cell 140 or the control of the fuel quantity to be supplied to the reformer 120, which are conducted by the controller 160, can change the amount of hydrogen contained in the offgas as the unreacted gas discharged from the fuel cell 140 on the temperature information from the temperature detector 161. Therefore, the thermal energy generated at the combustor 121 can be controlled. Then, if the thermal energy generated at the combustor 121 can be controlled and the reformer 120 or the combustor 121 as the high temperature reactor is joined transferably in heat with the CO transformer 130 as the low temperature reactor via the heat transmission joint 50 with the heat transmission controller 40, the heat quantity to be transferred to the low temperature reactor from the high temperature reactor can be controlled.

Moreover, in the fuel cell system 100, since the CO transformer 130 is heated by the thermal energy generated from the combustor 121 at high conversion efficiency by controlling the amount of hydrogen contained in the offgas discharged from the fuel cell 140, the amount of hydrogen corresponding to the heat quantity to be required for heating the CO transformer 130 can be saved in comparison with the use of the electrothermal heater.

### EXAMPLE

In this example, the relation between an outside air temperature and the temperature of the low temperature reactor 30 will be described when the high temperature reactor 20 is joined with the low temperature reactor 30 via only the heat transmission joint (Comparative Example 1) and when the high temperature reactor 20 is joined with the low temperature reactor 30 via the heat transmission joint 50 with the heat transmission controller 40 (Example 1).

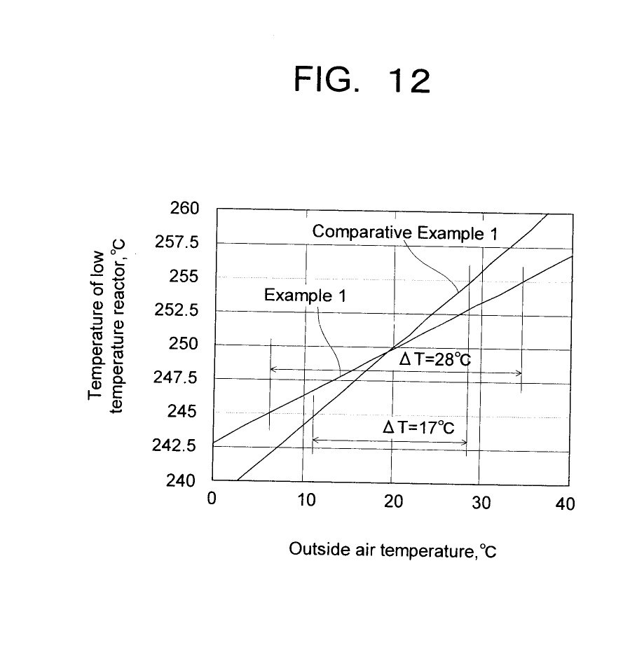

FIG. 11 is a calculation model for the temperature control when the high temperature reactor 20 is joined with the low temperature reactor 30 via the heat transmission joint 50 with the heat transmission controller 40 in Example 1. In this example, a calculation model for the temperature control when the high temperature reactor 20 is joined with the low temperature reactor 30 via only the heat transmission joint in Comparative Example 1 is not represented, but can be considered as the above-mentioned calculation model relating to Example 1 except that the heat transmission controller 40 is not provided. FIG. 12 is a graph showing the relation between the outside temperature and the low temperature reactor 30.

In the calculation model, the temperature of the high temperature reactor 20 is set to 350° C., and the temperature of the low temperature reactor 30 is set to 250° C. Then, suppose that the temperature sensitive member 42 of the heat transmission joint 50 with the heat transmission controller 40 is made of bimetal. The deformation degree D of the bimetal constituting the temperature sensitive member 42 is calculated from the equation (4). The deformation degree D is utilized as a calculation parameter. In the calculation, the thermal contact resistance R is also utilized as a calculation parameter. In the calculation, suppose that the temperature control by the electrothermal heater is not conducted. Moreover, in the calculation, suppose that the high temperature reactor 20 and the low temperature reactor 30 are set in the heat insulating container 110 of which the one end is opened.

$$D = \frac{K ( {T}_{H} - {T}_{L} ) {I}^{2}}{t} \qquad [ Equation 4 ]$$

Herein, “K” is a curved coefficient, “T_{H}−T_{L}” is a temperature difference, “l” is an effective length and “t” is a board thickness.

As is shown in FIG. 12, it is apparent that the low temperature reactor 30 in Comparative Example 1 is varied more largely than the low temperature reactor 30 in Example 1 within an outside air temperature range of 0 to 40° C. In view of the general operation of the low temperature reactor 30, the allowable temperature range is set to ±5° C. for the desired temperature. In Example 1, the allowable temperature variation range (ΔT) of the outside air temperature for the allowable temperature range of the low temperature reactor 30 is about 28° C., and in Comparative Example 1, the allowable temperature variation range (ΔT) of the outside air temperature for the allowable temperature range of the low temperature reactor 30 is about 17° C. In Example 1, therefore, since the high temperature reactor 20 is joined with the low temperature reactor 30 via the heat transmission joint 50 with the heat transmission controller 40, the operation of the low temperature reactor 30 is unlikely to suffer from the outside air temperature so that the allowable temperature variation range (ΔT) of the outside air temperature can be enlarged.

Although the present invention was described in detail with reference to the above examples, this invention is not limited to the above disclosure and every kind of variation and modification may be made without departing from the scope of the present invention.

What is claimed is:

1. A chemical reacting system, comprising:
a high temperature reactor;
a low temperature reactor where a reaction is conducted at a lower temperature than in said high temperature reactor; and
a heat transmission joint with a heat transmission controller to join said high temperature reactor tranferably in heat with said low temperature reactor so as to change a transferable heat cross section, thereby controlling a heat quantity to be transferred from said high temperature reactor to said low temperature reactor.

2. The chemical reacting system as set forth in claim 1,
wherein said heat transmission joint includes a trench between said high temperature reactor and said low temperature reactor so as to be crossed with a heat transmission direction; and
wherein said heat transmission joint includes a heat transmission fitter to be fitted in said trench of said heat transmission joint and a temperature sensitive member for pressing and fitting said heat transmission fitter in said trench of said heat transmission joint.

3. The chemical reacting system as set forth in claim 2,
wherein one end of said temperature sensitive member is fixed to said heat transmission joint and the other end of said temperature sensitive member is set to be free so as to be engaged with said heat transmission fitter, or
wherein one end of said temperature sensitive member is fixed to said heat transmission fitter and the other end of said temperature sensitive member is set to be free so as to be engaged with said heat transmission joint.

4. The chemical reacting system as set forth in claim 2,
wherein said temperature sensitive member is made of a bimetal or a shape-memory alloy.

5. The chemical reacting system as set forth in claim 3,
wherein said temperature sensitive member is made of a bimetal or a shape-memory alloy.

6. A fuel cell system, comprising:
a high temperature reactor to reform a fuel into a reformed gas containing hydrogen;
a low temperature reactor to conduct a reaction for the reduction of amount of carbon monoxide contained in said reformed gas at a lower temperature than in said high temperature reactor;
a fuel cell to generate an electric power by using said reformed gas discharged from said low temperature reactor;
a combustor to combust an unreacted gas discharged from said fuel cell;
a heat transmission joint with a heat transmission controller to join said high temperature reactor transferably in heat with said low temperature reactor so as to change a transferable heat cross section, thereby controlling a heat quantity to be transferred from said high temperature reactor to said low temperature reactor;
a temperature detector to detect a temperature of said high temperature reactor or said combustor; and
a controller, on said temperature detected by said temperature detector, to control said electric power to be generated at said fuel cell and change an amount of hydrogen contained in said unreacted gas discharged from said fuel cell.

7. A fuel cell system, comprising:
a high temperature reactor to reform a fuel into a reformed gas containing hydrogen;
a low temperature reactor to conduct a reaction for the reduction of amount of carbon monoxide contained in said reformed gas at a lower temperature than in said high temperature reactor;
a fuel cell to generate an electric power by using said reformed gas discharged from said low temperature reactor;
a combustor to combust an unreacted gas discharged from said fuel cell;
a heat transmission joint with a heat transmission controller to join said high temperature reactor transferably in heat with said low temperature reactor so as to change a transferable heat cross section, thereby controlling a heat quantity to be transferred from said high temperature reactor to said low temperature reactor;
a temperature detector to detect a temperature of said high temperature reactor or said combustor; and
a controller, on said temperature detected by said temperature detector, to control an amount of said fuel to be supplied to said high temperature reactor and change an amount of hydrogen contained in said unreacted gas discharged from said fuel cell.

8. The fuel cell system as set forth in claim 6,
wherein said heat transmission joint includes a trench between said high temperature reactor and said low temperature reactor so as to be crossed with a heat transmission direction; and
wherein said heat transmission joint includes a heat transmission fitter to be fitted in said trench of said heat transmission joint and a temperature sensitive member for pressing and fitting said heat transmission fitter in said trench of said heat transmission joint.

9. The fuel cell system as set forth in claim 7,
wherein said heat transmission joint includes a trench between said high temperature reactor and said low temperature reactor so as to be crossed with a heat transmission direction; and
wherein said heat transmission joint includes a heat transmission fitter to be fitted in said trench of said heat transmission joint and a temperature sensitive member for pressing and fitting said heat transmission fitter in said trench of said heat transmission joint.

10. The fuel cell system as set forth in claim 8,
wherein one end of said temperature sensitive member is fixed to said heat transmission joint and the other end of said temperature sensitive member is set to be free so as to be engaged with said heat transmission fitter, or
wherein one end of said temperature sensitive member is fixed to said heat transmission fitter and the other end of said temperature sensitive member is set to be free so as to be engaged with said heat transmission joint.

11. The fuel cell system as set forth in claim 9,
wherein one end of said temperature sensitive member is fixed to said heat transmission joint and the other end of said temperature sensitive member is set to be free so as to be engaged with said heat transmission fitter, or
wherein one end of said temperature sensitive member is fixed to said heat transmission fitter and the other end of said temperature sensitive member is set to be free so as to be engaged with said heat transmission joint.

12. The fuel cell system as set forth in claim 8,
wherein said temperature sensitive member is made of a bimetal or a shape-memory alloy.

13. The fuel cell system as set forth in claim 9,
wherein said temperature sensitive member is made of a bimetal or a shape-memory alloy.
